(19) United States
(12) Patent Application Publication
(10) Pub. No.: US 2021/0403067 A1
(43) Pub. Date: Dec. 30, 2021

(54) SHOPPING CART SYSTEM

(71) Applicant: Zhuangyong Chen, Cumming, GA (US)

(72) Inventor: Zhuangyong Chen, Cumming, GA (US)

(21) Appl. No.: 17/471,705

(22) Filed: Sep. 10, 2021

Related U.S. Application Data
(60) Provisional application No. 63/213,479, filed on Jun. 22, 2021.

(51) Int. Cl. B62B 5/00; B62B 3/14; G07G 1/00

(52) U.S. Cl. CPC B62B 5/0096; G07G 1/0081; B62B 3/14

(57) ABSTRACT

A shopping cart system that includes an image that can be applied to the packaging of an item. The image may be invisible in a visible light spectrum but only visible in radiations of a specific spectrum or within a range of wavelengths that are outside the visible light spectrum. An optical scanner unit that can scan the image on the package. The optical scanner unit can include a lamp that can generate the radiations in the specific spectrum in which the image can be scanned. The optical scanner unit can be mounted to a shopping cart such as to track items being placed or removed from the shopping cart.

### CROSS-REFERENCE TO RELATED APPLICATIONS

This application claims priority from the U.S. provisional patent application Ser. No. 63/213,479, filed on Jun. 22, 2021, which is incorporated herein by reference in its entirety.

### FIELD OF INVENTION

The present invention relates to a shopping cart system, and more particularly, the present invention relates to a shopping cart system that can track additions and removals of items from the shopping cart.

### BACKGROUND

While shopping at a supermarket or in a store, people generally add items to a basket, referred to as a shopping cart. A shopping cart generally has wheels and a handle to push the cart. While shopping, the user can add items and also remove the added items from the shopping cart. For example, the user may find a better alternative to an item in the shopping cart, and so the user removes the item from the shopping cart and add the alternative item. Once done shopping, the user with the shopping cart approaches a checkout counter, also known as the point-of-sale counter. The checkout process has been a time-consuming task and generally, the people have to wait long in queues. Most of the time spent during the checkout process involves the cashier taking the items from the shopping cart, sorting the items, and scanning the items. The customer then pays for the items and collects the receipt and the items from the cashier or any other checkout point in the store.

The aforesaid checkout process is slow requiring the consumers to wait long in queues for their turn. The customers' shopping experience gets worse during the store's busy hours or a sale going on in the store. Besides the customer experience, the checkout process has been a labor-intensive process. The workforce management at stores can be both complex and costly. Thus, a need is appreciated for a system that can ease the checkout process for customers and make the checkout process simpler and cost-effective for the store.

The term “image” herein after connotes a machine-readable representation of a code in a visual pattern that can be scanned by a machine for reading the code and includes a Barcode.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for automated billing of items in a shopping cart.

It is another object of the present invention that the system and method can track items being added or removed from the shopping cart.

It is still another object of the present invention that the implementation of the system and method is economical.

It is yet another object of the present invention that the operational cost of the store or super marked can be dramatically reduced.

It is a further object of the present invention to better the shopping experience of the customers at the store.

It is an additional object of the present invention that the customers can buy the product more quickly.

It is still an additional object of the present invention that the customers do not have to stand in long queues for checkout.

It is still a further object of the present invention that the customer can get a real-time estimate of the bill during shopping.

It is yet a further object of the present invention that information related to a product added to the shopping cart, such as an applicable offer or related products can be presented to the customer in real-time.

In one aspect, disclosed is a shopping cart system that includes an image that can be applied to the packaging of an item. The image may be invisible in a visible light spectrum but only visible in radiations of a specific spectrum or within a range of wavelengths that are outside the visible light spectrum. The disclosed shopping cart system can further include an optical scanner unit that can scan the image on the package. The optical scanner unit can include a lamp that can generate the radiations of the specific spectrum in which the image can be scanned.

In one aspect, one or more optical scanner units can be mounted to a shopping cart, preferably at a top corner of the shopping cart, such as the open top of the shopping cart can be within a view field of the optical scanner unit.

In one aspect, the disclosed system can track items added or removed from the shopping cart by scanning the image on the item by the optical scanner unit.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing the architecture of the shopping cart system, according to an exemplary embodiment of the present invention.

FIG. 2 shows an optical scanner unit mounted to a shopping cart, according to an exemplary embodiment of the present invention.

FIG. 3 shows a different arrangement of optical scanner units mounted to two racks of the shopping cart, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

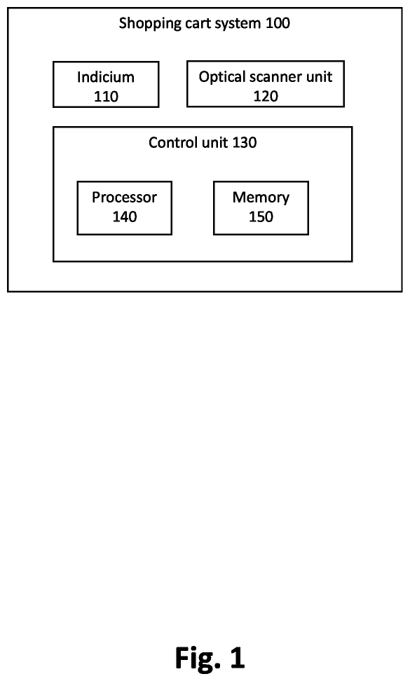

Disclosed are a shopping cart system and method for tracking items added to a shopping cart and removed from the shopping cart. The disclosed shopping cart system can provide a list of items in the shopping cart at any given time. The disclosed shopping cart system can provide for a quicker checkout by populating the list of items in the shopping cart placed by the customer. The cashier no longer has to pick the items from the shopping cart and scan them, but a list of items in the shopping cart can be received from the disclosed shopping cart system and the bill can be prepared from the list of items. Referring to FIG. 1, which shows the disclosed shopping cart system 100 having a control unit 130 that can include a processor 140 and a memory 150. The shopping cart system 100 can further include an optical scanner unit 120 and an image 110. The image can be applied to an item's packaging and can represent a unique code associated with the respective item. The image can be similar to a barcode that is used to identify an item based on a unique id assigned to the item. The image can be printed on two or more faces of the packaging, and preferably on all the faces of the packaging.

The image can be printed using a proprietary ink, such as the image may not be visible in the visible spectrum of light but may be visible only in a specific spectrum or within a predetermined range of wavelengths that are outside the visible spectrum of light. The image therefore may not interfere with the appearance of the items or their packaging. For example, the items can be displayed as such in the racks of the store without any interference in appearance by the image. The image can be applied by the manufacturer on their goods, or it can be applied in the store, or it can be applied at any intermediate point between the manufacture and distribution of the goods. The image can be applied without modifying or redesigning the packaging.

The optical scanner unit 120 can scan the image to read the unique code represented by the image and associated with the respective item to which the image is applied. The optical scanner unit 120 can include a lamp that can generate light in the specific spectrum in which the image can be scanned by the optical scanner unit. The image may or may not be visible to the eyes even in the specific spectrum. The optical scanner unit 140 can be connected to the control unit 130, wherein the control unit can receive a signal from the optical scanner unit 140 indicative of the scanning of the item by the optical scanner unit.

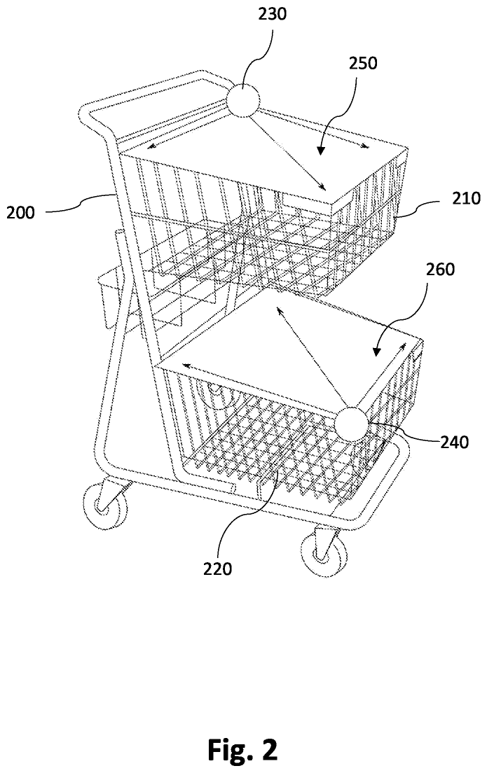

Referring to FIG. 2 shows a generic shopping cart 200 that has two racks, i.e. an upper rack 210 mounted above a lower rack 220 in a frame. Two optical scanner units can also be seen mounted to the upper rack and the lower rack. A first optical scanner unit 230 can be mounted to a top corner of the upper rack 210 and a second optical scanner unit 240 can be mounted to a top corner of the lower rack 220. The optical scanner unit can be mounted such as to cover an open-top area of the rack i.e., the open-top area of the rack can be within a view field of the optical scanner unit and any article passing through the open top area of the rack can be scanned by the optical scanner unit. FIG. 2 shows a plane 250 extending along the top of the upper rack 210 with three arrows extending from the optical scanner unit 230, the plane 250 represents the view field of the optical scanner unit 230. Similarly, a plane 260 may show the view field of the optical scanner unit 240 at top of the lower rack 220.

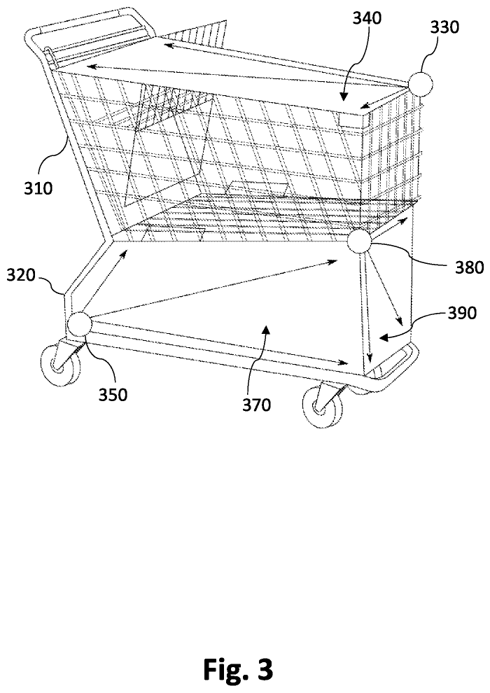

In one case, more than one optical scanner unit can be used to cover the shopping cart 200. For example, FIG. 3 shows a shopping cart 300 that includes two racks 310 and 320 one above another. One optical scanner 330 can be seen in the top corner of the upper rack 310 having its view field shown by the plane 340. It is to be understood that more than one optical scanner unit can be used for a single rack and the position of the optical scanner units can be optimized and any position of the optical scanner unit on the shopping cart is within the scope of the present invention. the lower rack in FIG. 3 shows one camera 350 at the lower corner of the lower rack 320 wherein the one camera 350 covers the right space shown by plane 370 and any article placed in the lower rack from the right side into the lower rack can be scanned by the one camera 350. A second camera 380 can be positioned at a bottom corner of the upper rack 310 and covering the front open area as shown by a plane 390 between the upper rack and the lower rack and can scan any article dropped into the lower rack 320. Similarly, a third camera can cover a plane opposite to the plane 370.

The control unit can also be mounted in the shopping cart and electrically connected to the optical scanner unit also mounted in the shopping cart. The optical scanner unit can be connected to the control unit through a wired or wireless connection. Also, the control unit can be located outside the shopping cart and wirelessly connected to the optical scanner unit. Also, more than one optical scanner unit can be connected to a single control unit. Or a single optical scanner unit can be connected to a single control unit. Or a centralized control unit can be wirelessly connected to several optical scanner units mounted in shopping carts in a store or supermarket.

In one exemplary embodiment, when a user adds an item to the shopping cart, the item passes through the open top of the shopping cart and into the shopping cart. The optical scanner unit 140 can scan the image applied on the item while passing through the open top of the shopping cart into the shopping cart. By applying the image on all the faces of the packaging, the items can be scanned irrespective of the orientation of the item being dropped in the shopping cart. Similarly, when the item is taken out of the cart, the item can be scanned by the optical scanner unit.

The control unit can receive a signal from the optical scanner unit, the signal indicative of an item being added to the shopping or removed from the shopping cart. The control unit can include an application software stored in the memory which can be executed by the processor to interpret the signal for determining the unique code represented by the image and associated with the respective item. The control unit can also include the inventory details, such as details of items in the store. The details of items can include items and their associated code. When a new code is scanned by the optical scanner unit, the item associated with the code can be added to a present list of items. When a scanned code received by the control unit is already present in the list, this may indicate that the item is being removed from the shopping cart and the item can be removed from the present list of items.

In one exemplary embodiment, the list of items from the control unit indicates the items in the shopping cart at any given time. The consumer while shopping can know at any time the items collected in the shopping cart. In one case, the control unit can be connected to a display, such as an LCD screen or a smartphone. The control unit can present on the display, the list of items indicating the items in the shopping cart. The consumer can also know the estimated amount of the items in the shopping cart. In one case, knowing the estimate of items while shopping can help the customer shop within his budget and prevents unnecessary removal of the items from the cart later.

In one exemplary embodiment, the control unit can also receive information on the items, such as an offer on the product or related products. The control unit can present such information to the consumer while shopping based on the product added by the consumer in the shopping cart or removed from the shopping cart. Upon receiving the signal from the optical scanner unit, the control unit can determine which product which is added to the shopping cart or removed from the shopping cart. The control unit can present information related to that item on the display. For example, the customer can be informed about an offer on the product taken by the customer.

When the consumer has finished with the shopping, the list of items from the control unit can be used to prepare a bill and the payment can be received from the consumer. The items in the shopping cart can be removed and packed. The disclosed system can perform a validation check for the list of items. When the item is removed from the shopping cart, it can be scanned again by the optical scanner unit and can be matched to billed items.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A shopping cart system comprising:
an image configured to be applied to an item, the image representative of a unique code associated with the item, the image configured to be invisible in a visible light spectrum but is visible in radiations of a predetermined range of wavelengths outside the visible light spectrum;
an optical scanner unit configured to scan the image, wherein the optical scanner unit configured to be mounted to a shopping cart such as to scan an item passing through an open top of the shopping cart; and
a control unit operably coupled to the optical scanner unit and configured to:
receive a signal from the optical scanner unit, the signal indicative of the item having the image scanned by the optical scanner unit while passing through the open top of the shopping cart, and
add the item to a list of items.

2. The shopping cart system according to claim 1, wherein the image is a bar code.

3. The shopping cart system according to claim 1, wherein the optical scanner unit further comprises a lamp configured to generate the radiations.

4. The shopping cart system according to claim 1, wherein the shopping cart system further comprises the shopping cart and the optical scanner unit mounted to the shopping cart.

5. The shopping cart system according to claim 4, wherein the optical scanner unit is mounted at a top corner of the shopping cart.

6. The shopping cart system according to claim 4, wherein the shopping cart comprises two racks, an upper rack and a lower rack, the lower rack mounted below the upper rack in a frame, and one optical scanner unit is mounted at a top corner of the upper rack, and three optical scanner units mounted at three corners of the lower rack.

7. A method for tracking addition and removal of items from a shopping cart, the method comprising the steps of:
applying an image on an item, the image representative of a unique code associated with the item, the image configured to be invisible in a visible light spectrum but is visible in radiations of a predetermined range of wavelengths;
scanning the item being placed in a shopping cart by an optical scanner unit, the optical scanner unit mounted to the shopping cart;
receiving by a control unit coupled to the optical scanner unit a signal indicative of scanning of the item;
upon receiving the signal, adding the item to a list of items.

8. The method according to claim 7, wherein the method further comprises the steps of:
upon adding the item, receiving a second signal from the optical scanner unit indicative of scanning of the item; and
upon receiving the second signal, removing the item from the list of items.

9. The method according to claim 7, wherein the image is applied to cover all faces of the item.

10. A method for managing a checkout process in a store, the method comprising the steps of:
proving a shopping cart management system comprising:
a plurality of images configured to be applied to a plurality of items in the store, each image of the plurality of images representative of a unique code associated with the respective item, the each image configured to be invisible in a visible light spectrum but is visible in radiations of a predetermined range of wavelengths outside the visible light spectrum,
an optical scanner unit configured to scan the image, wherein the optical scanner unit configured to be mounted to a shopping cart such as to scan an item passing through an open top of the shopping cart; and
a control unit operably coupled to the optical scanner unit and configured to:
receive a signal from the optical scanner unit, the signal indicative of scanning of an item of the plurality of items while passing through an open top of the shopping cart, and
add the item to a list of items;
applying the plurality of images to the plurality of items in the store, such as the each image covers all faces of the respective item;
mounting the optical scanner unit to the shopping cart;
receiving the signal by the control unit;
adding the item associated with the signal to the list of items; and
present the list of items.
